(19) United States
(12) Patent Application Publication
(10) Pub. No.: US 2002/0082761 A1
(43) Pub. Date: Jun. 27, 2002

(54) Method for operating a torque-converter lockup clutch for a hydrodynamic torque converter and control device for implementing the method

(76) Inventor: Peter Baeuerle, Ludwigsburg (DE)

Correspondence Address: KENYON & KENYON, ONE BROADWAY, NEW YORK, NY, 10004, US

(21) Appl. No.: 09/976,788

(22) Filed: Oct. 12, 2001

(30) Foreign Application Priority Data
Oct. 14, 2000 (DE) 100 51 017.5

(51) Int. Cl. G06F 19/00

(52) U.S. Cl. 701/67; 701/51

(57) ABSTRACT

A method for operating a torque-converter lockup clutch (20) for a hydrodynamic converter (1), where the slip (s) of the torque converter (1) is adjusted using a setpoint value (sw), while the torque-converter lockup clutch (20) is being closed. The method is also designed with the intention of providing an especially high degree of ride comfort while the torque-converter lockup clutch (20) is being closed. In addition, the present invention provides for the setpoint value (sw) being continuously selected as a function of time, inside a closing interval, taking into consideration the input torque (E) currently being applied to the torque converter (1). A control device (24) particularly suitable for implementing the method includes a control unit (26), which selects a setpoint value (sw) for the slip (s) of the converter (1) as a function of time, and taking into consideration the input torque (E) currently being applied to the torque converter (1).

The present invention relates to a method for operating a torque-converter lockup clutch for a hydrodynamic torque converter, where the slip of the torque converter is adjusted using a setpoint value, when the torque-converter lockup clutch is being closed. The present invention also relates to a control device for implementing the method.

A hydrodynamic torque converter, which is driven by an internal combustion engine and, e.g. connected to an automatic multi-speed transmission or a continuously variable transmission on the output side, can be used in the power train of a motor vehicle. In this context, the torque converter usually transmits a torque supplied to its input shaft, via a combination of a so-called pump unit and a so-called turbine unit, to an output shaft which, for its part, can be used as an input shaft for the subsequent transmission. For its part, the transmission can be connected, via its output shaft or drive shaft, to a number of driven wheels of the motor vehicle.

In this connection, the torque converter can, for its part, be provided with a torque-converter lockup clutch. Such a torque-converter lockup clutch connects the input and output shafts of the converter, thereby reducing the converter losses. In the operating state in which load changes occur, the torque-converter lockup clutch is usually opened in order to damp abrupt load changes; therefore, the response characteristic and, in particular, the speed ratio of the speed of the output shaft to the speed of the input shaft are exclusively determined by the torque converter as such. In the approximately uniform steady-state condition, the torque-converter lockup clutch can, however, be closed to reduce the converter losses, so that the pump unit and the turbine unit of the torque converter and, therefore, its input and output shafts as well, can be rigidly coupled to each other and, in particular, have the same speed. The torque converter lockup clutch can, for example, have a first coupling element rigidly connected to the turbine unit and a second, adjustable coupling element positioned against it, e.g. an actuating piston, which can be brought into contact with the pump unit.

In order to prevent an abrupt change in the driving parameters and the associated loss of comfort for the driver, the closing operation of such a torque-converter lockup clutch is normally extended over a temporal closing interval. Over this closing interval, the second coupling element is brought into contact with the pump unit, e.g. by continuously intensifying a clamping force or pressure, so that the speeds of the input and output shafts approach each other, and, toward the end of the closing interval, an increasingly large share of the torque is transmitted by the closing clutch. During the closing operation, the torque-converter lockup clutch can be operated in a slip-controlled manner, the slip determined by the difference of the input-shaft or pump-unit speed and the output-shaft or turbine-unit speed of the converter being monitored, and being adjusted to a setpoint value by appropriate selection of the contact force or contact pressure as a controlled parameter. In this context, a value continuously decreasing as a function of time can be selected as a setpoint value, inside the closing interval, so that a gradual transition into the closed state of the torque-converter lockup clutch is ensured.

The present invention is based on the object of specifying a method for operating a torque-converter lockup clutch of the type mentioned above, in which an especially high degree of ride comfort is also ensured while the torque-converter lockup clutch is being closed. The intention is also to specify a control device that is particularly suitable for implementing the method.

With regard to the method, the object of the present invention is achieved in that the setpoint value is continuously selected as a function of time, and taking into consideration the input torque currently being applied to the torque converter.

Advantageous refinements of the present invention are the subject matter of the dependent claims.

The present invention starts out from the consideration that, on one hand, the setpoint value for the clutch slip should be further selected as a function of time, in order to ensure a reliable and precise closing operation. But on the other hand, an abrupt change in the handling as a result of rapidly changing operating parameters should also be controlled, in order to ensure a high degree of riding comfort, especially in the case of extended closing intervals taking a comparatively long time.

In the case of a temporally extended closing interval, the input torque applied to the torque converter can especially change in the short term. In this instance, an abruptly falling input torque would, for example, result in the slip level generally attainable by the torque converter falling sharply in a short time span. This could cause the actual slip level to be lower than the setpoint slip value actually intended for the continuous transition over time. In reaction to this, the slip control system would open the torque-converter lockup clutch completely. In order to prevent the resulting, undesirable variability in the handling, it is intended that the input torque currently being applied to the torque converter be considered in the determination of the setpoint value for controlling the slip of the torque-converter lockup clutch.

In this context, a uniform transition from the open state into the closed state of the torque-converter lockup clutch can be achieved by advantageously considering a preselected time characteristic for the time-dependence of the setpoint value, the preselected time characteristic converting the slip present at the beginning of the closing interval as an initial value into a target value, within the closing interval. In a particularly advantageous refinement, a linear transition from the initial value to the target value is provided as a time characteristic.

In this context, the time characteristic for converting the initial value into the target value can be preselected for a large multitude of possible initial values, the actual time characteristic to be kept being selected as a function of the actual slip value existing at the beginning of the closing interval, as an initial value. In order to correct the setpoint value in a particularly effective manner, the input torque applied to the torque converter is monitored inside the closing interval; in response to the input torque changing by more than a specifiable tolerance deviation, the slip of the torque converter being calculated and used as a new initial value, which would appear at this input torque in the case of a completely opened torque-converter lockup clutch. In this context, the value resulting from the preselected time characteristic for the current time inside the closing interval is selected as the setpoint value for the slip, the time characteristic converting the initial value ascertained with the aid of the currently applied input torque into the target value. In other words, it is determined for the currently applied input torque, which slip of the torque converter would be set for this input torque in the case of the a completely opened torque-converter lockup clutch. This slip value derived from the input torque is used as an initial value. The time characteristic selected for converting this initial value into the target value is then taken into consideration for the setpoint value.

In this context, the slip forming the basis of the new initial value is advantageously determined from the applied input torque, using a stored characteristics map, or by calculating it from the applied input torque, taking the performance figure of the torque converter into consideration. The characteristics map can have been ascertained, for example, with the aid of a number of calibration measurements.

However, the following equation can be used as a basis for the alternatively provided calculation of the initial slip value from the applied input torque,

Mₚᵤₘₚ=K*Λ*10³*(nₚᵤₘₚ·1000)²

where Mₚᵤₘₚ is the input torque, K is a conversion factor, A is the performance figure, and nₚᵤₘₚ is the pump speed. Using this equation as a starting point, performance figure Λ can be ascertained from input torque Mₚᵤₘₚ when pump speed nₚᵤₘₚ is known. For its part, the performance figure, as a type of torque-converter characteristic, is clearly a function of the ratio of the output-shaft speed or the turbine speed to the input-shaft speed or the pump speed of the torque converter. When the relationship between performance figure Λ and the speed ratio of the torque converter is known, the speed ratio of the torque converter can therefore be determined from performance figure Λ. The slip of the torque converter, which is to be utilized as an initial value, can again be calculated from the speed ratio of the torque converter.

To adjust the slip to the setpoint value obtained in this manner, a controlled parameter is provided for setting the contact pressure for the torque converter.

The identification of a particularly suitable starting time for controlling the slip of the torque-converter lockup clutch is also favorable for a particularly high degree of riding comfort during the closing of the torque-converter lockup clutch. The time, as of which the torque-converter lockup clutch can transmit a torque, is advantageously designated as a particularly suitable starting time, as of which the torque-converter lockup clutch can be operated in a controlled manner. This time sets in after the second adjustable coupling element of the torque-converter lockup clutch is brought into mechanical contact with the first coupling element, and therefore, e.g. when the actuating piston of the torque-converter lockup clutch comes into contact with the pump unit. To detect this instant and ascertain the start of power transmission in the torque-converter lockup clutch, the time characteristic of the slip is advantageously monitored for a decline. After such a decline is detected, the slip control system of the torque-converter lockup clutch is activated, a clamping pressure for the torque converter being set as a function of a coupling torque to be transmitted, and as a function of a setpoint slip value for the torque-converter lockup clutch.

With regard to the control device for a torque-converter lockup clutch, the specified object is achieved by connecting a sensor for detecting the input torque applied to the torque converter, to a control unit, which selects a setpoint value for the torque-converter slip as a function of time, and taking into consideration the input torque currently being applied to the torque converter.

In this context, the output side of the control unit is connected to means for setting a clamping pressure for the torque converter. In another advantageous design, the control unit is connected to a data storage unit, in which a time characteristic for the setpoint slip value is stored. The slip existing at the beginning of a closing interval is converted, as an initial value, to a target value, within the closing interval, in accordance with the time characteristic for the setpoint slip value.

In a further advantageous refinement, the data storage unit has a data record stored in it, from which a slip value can be derived for each input torque. The slip value, as an initial value, is to used as a basis for determining the setpoint slip value as a function of time. In an alternative advantageous refinement, a characteristics map is stored which assigns each performance figure of the torque converter a corresponding slip value within specifiable interval boundaries. Therefore, this refinement allows a suitable initial value for the slip to be ascertained as a function of the input torque of the torque converter.

In particular, the advantages attained by the present invention are that, by taking the input torque currently applied to the torque converter into consideration in selecting a current setpoint value for the slip of the torque-converter lockup clutch, the controller response can almost be simultaneously adjusted to changing operating parameters. In particular, the setpoint value can be kept current in a manner allowing especially comfortable handling without distinctly noticeable, abrupt changes in the response characteristic of the torque converter. In addition, a particularly uniform response characteristic can already be achieved at the beginning of the closing operation by determining an especially suitable starting time for controlling the slip of the torque-converter lockup clutch.

An exemplary embodiment of the present invention is explained in detail with reference to a drawing, in which is shown:

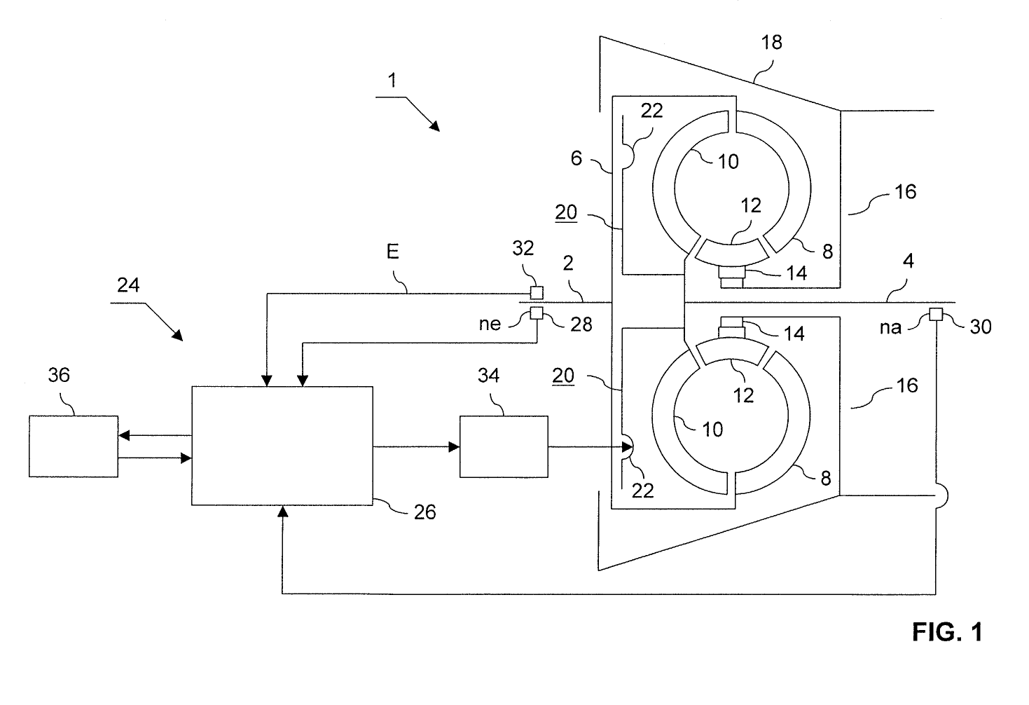

FIG. 1 a longitudinal cross section of a hydrodynamic converter, along with an associated control device;

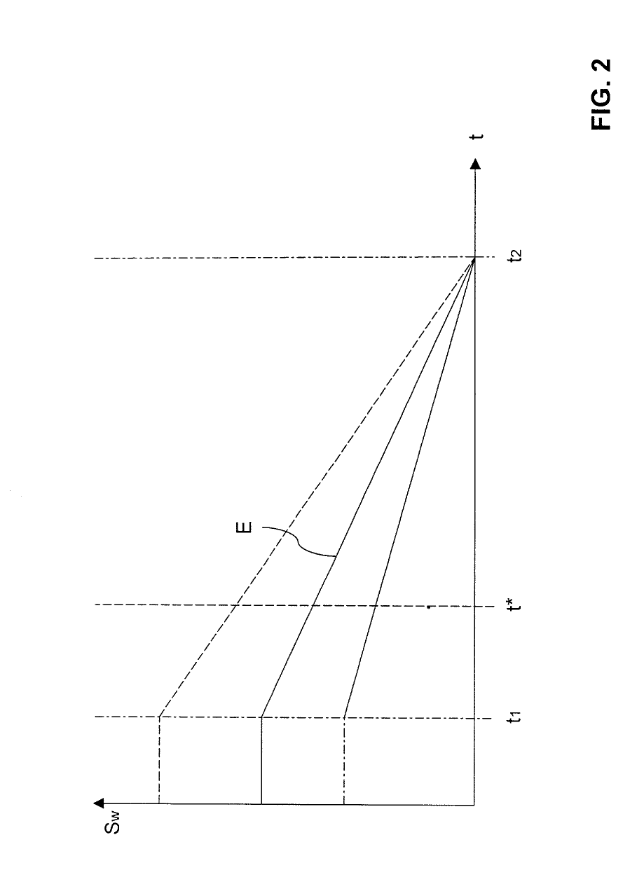

FIG. 2 a timing diagram for the time characteristic of a setpoint value;

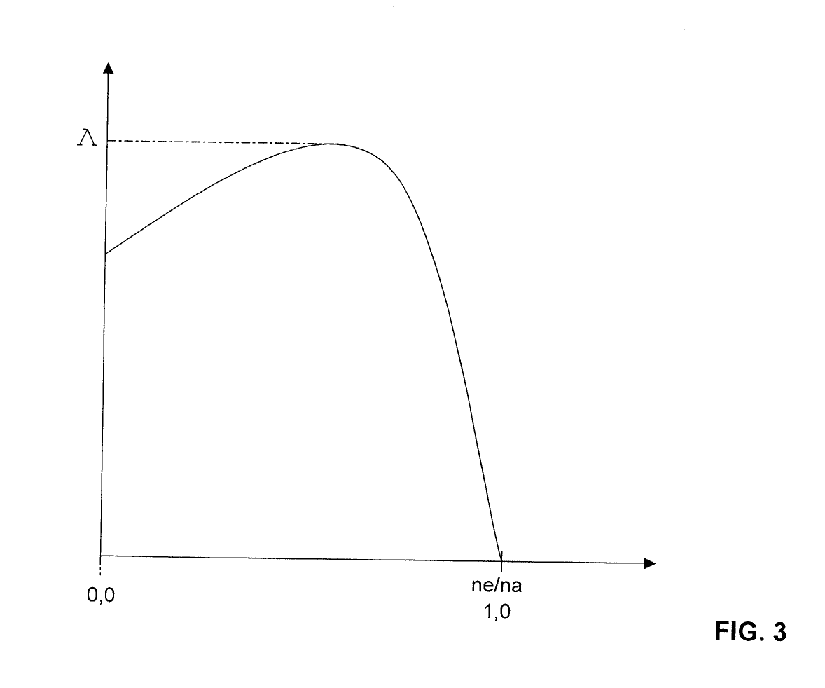

FIG. 3 a characteristic curve for the dependence of the performance figure of the converter on its speed ratio; and

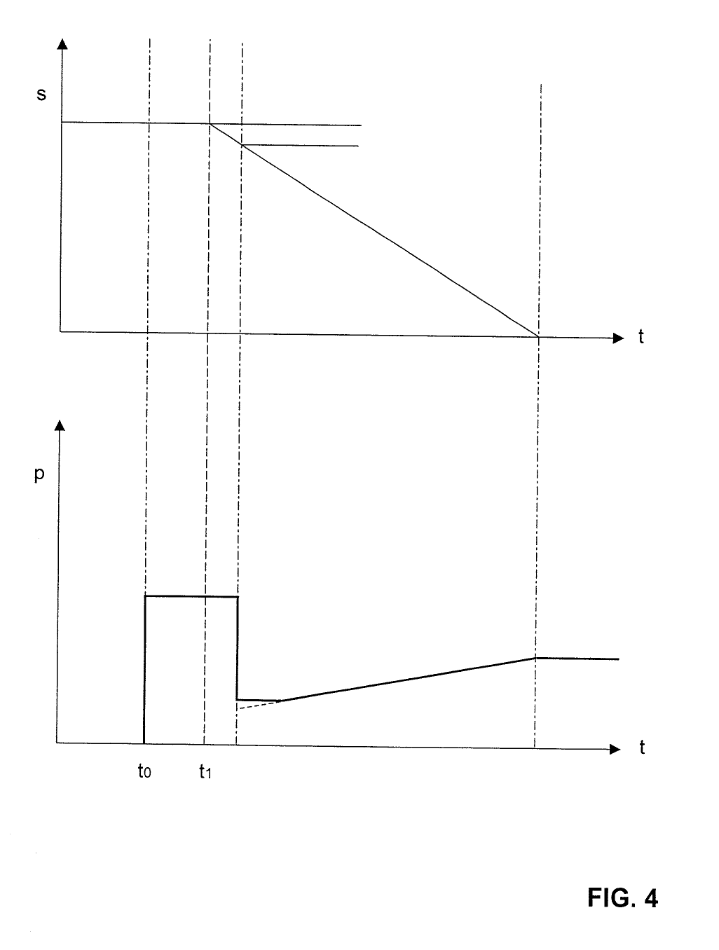

FIG. 4 a common timing diagram for the time characteristic of a setpoint value, and for the time characteristic of a controlled parameter.

The hydrodynamic converter 1 according to FIG. 1 is intended for use as a torque converter in the power train of a motor vehicle not represented in further detail. On the input side, converter 1 is connected via an input shaft 2 to an internal combustion engine or motor vehicle engine, and can be driven by it. On the output side, converter 1 is connected via an output shaft 4 to a vehicle transmission which, in the exemplary embodiment, is namely an automatic multi-speed transmission. The vehicle transmission is in turn connected, via an additional output shaft or drive shaft, to a number of driven wheels of the motor vehicle. In the exemplary embodiment, output shaft 4 of converter 1 is used, for its part, as an input shaft for the succeeding vehicle transmission. As an alternative, a continuously variable transmission or another suitable vehicle transmission can also be provided as a vehicle transmission.

In order to transmit a torque supplied to input shaft 2 to output shaft 4, converter 1 includes an interacting combination of a pump unit 8 connected to input shaft 2 via a housing part 6, and a turbine unit 10 connected to output shaft 4. In this context, pump unit 8 and turbine unit 10 each include a number of turbine blades mounted on a rotor, which are not represented in detail. The combination of pump unit 8 and turbine unit 10 is supplemented by a stator 12, which is connected to a transmission housing 16 via a freewheel set-up 14. Finally, the combination of pump unit 8 and turbine unit 10 is surrounded on the outside by a casing 18 which, together with housing part 6 and the corresponding part of transmission housing 16, constitutes a complete outer housing for converter 1.

In operation, the inner region of the housing surrounding converter 1 is filled with an operating liquid, e.g. with a hydraulic oil. In response to applying a torque or input torque E to input shaft 2, the input shaft rotates at a speed ne. Pump unit 8, which consequently rotates at speed ne as well, builds up operating-fluid pressure, by means of which a connection to turbine unit 10 is formed with the support of stator 12. Therefore, the turbine unit rotates as well, speed na of output shaft 4 being set as a function of input torque E, speed ne of input shaft 2, the load of output shaft 4, and the characteristic of converter 1. In the general operating case, speed na of output shaft 4 is different from speed ne of input shaft 2; therefore, a slip s, which is not equal to zero and is defined by the difference of speeds na and ne, is present when input torque E is transmitted by converter 1, as such.

In a study-state operation, in which no considerable, abrupt load changes occur, and in which the particularly flexible transmission characteristic of converter 1 is of little importance, an operation with permanent slip s can, however, disadvantageously lead to unwanted converter losses, without these being compensated for by corresponding advantages. In order to keep these converter losses low, converter 1 is provided with a torque-converter lockup clutch 20.In case it is necessary, the torque-converter lockup clutch produces a force-locked connection between input shaft 2 and output shaft 4, so that speeds ne, na are equal in this operating state, and the torque is directly transmitted, via the coupling of input shaft 2 and output shaft 4, while bypassing converter 1 as such. To this end, torque-converter lockup clutch 20 includes an actuating piston 22 as a coupling element, which is connected to output shaft 4 and can be brought into contact with housing part 6 in a friction-locked or force-locked manner.

In order for the motor vehicle to perform in a particularly comfortable manner, and to prevent undesirable load changes or torque surges, torque-converter lockup clutch 20 is designed in such a manner, that the transition from the opened state (in which applied input torque E is completely transmitted via converter 1 as such) into the close state (in which applied input torque E is completely transmitted via torque-converter lockup clutch 20, while bypassing converter 1) occurs in a temporally extended manner, over a closing interval. For this purpose, hydrodynamic converter 1 and, in particular, the torque-converter lockup clutch 20 designed as a slip-controlled clutch are assigned a control device 24, which adjusts the slip s defined by the difference of speed ne of input shaft 2 and speed na of output shaft 4, as a function of measured operating parameters, to a setpoint value sw. Control device 24 includes a control unit 26, which is connected on the input side to a sensor 28 for detecting speed ne of input shaft 2, and to a sensor 30 for detecting speed na of output shaft 4. In addition, the control unit is connected on the input side to a sensor 32 for detecting the input torque E applied to input shaft 2. In this context, sensor 32 can alternatively be integrated into another control device, e.g. an engine control unit. In other words, a parameter characterizing input torque E can be supplied by a sensor 32 specially provided for this reason, as is the case in the exemplary embodiment, or can be supplied by another control device, such as an engine control unit.

Control unit 26 is connected on the output side to an actuator 34, which acts on actuating piston 22 of torque-converter lockup clutch 20, and adjusts a clamping pressure for it as a function of a value selected by control unit 26. Furthermore, control unit 26 is connected to a data storage unit 36 for purposes of exchanging data.

To control slip, control unit 26 selects the value for the clamping pressure as a function of the actual value for slip s of converter 1 or torque-converter lockup clutch 20 calculated from the measured values supplied for speeds ne, na, and as a function of a preselected or calculated setpoint value sw. For a continuous closing operation of torque-converter lockup clutch 20, control unit 26 selects the manipulated-variable value for actuator 34 such that a time-dependent setpoint value sw for the clutch slip is maintained within a tolerance range. For the time-dependence of setpoint value sw, a preselected time characteristic stored in data storage unit 36 as a data record is taken into account, which converts the slip s existing at the beginning of the closing interval as an initial value into a target value, within the closing interval. In this context, the target value for slip s of torque-converter lockup clutch 20 can be selected as a function of the desired steady-state operation. If torque-converter lockup clutch 20 should be securely closed in steady-state operation, and speed na of output shaft 4 should be equal to speed ne of input shaft 2, then the value of 0 is to be selected as the target value for slip s. But if torque-converter lockup clutch 20 should also be operated as a slip-controlled clutch in steady-state operation, then a target value other than 0 is also possible for slip s.

The slip value, which is to be considered as an initial value for controlling slip during the closing interval, and is present at the beginning of the closing interval, is selected by the characteristic of converter 1, and is a function of the input torque E that is applied to input shaft 2 at this instant. In general, a larger input torque E at this instant also results in a larger initial value for slip s. Accordingly, an instruction is stored in data-storage unit 36, a suitable time characteristic for setpoint value sw of slip s during the closing interval being ascertainable from the instruction, for each value of input torque E at the beginning of the closing interval. In the exemplary embodiment, setpoint value sw is a linear function of time, it as is represented in the timing diagram according to FIG. 2, for three different values of input torque E at the beginning of the closing interval.

In the case of an extended closing interval that takes a comparatively long time, it is conceivable for input torque E applied to input shaft 2 to even change during the closing interval. In the case of a significant fall in the input torque E, this could, for example, lead to the slip s occurring at converter 1 as a result of this input torque E now being less than the setpoint value sw to be set in accordance with the currently selected time characteristic at this instant, even when torque-converter lockup clutch 20 is completely open. In order to approach setpoint value sw in the best possible manner, torque-converter lockup clutch 20 would therefore have to completely open again during the previously started closing interval. This would result in abrupt changes in the operating parameters and, therefore, a loss of comfort.

In order to prevent this, control unit 26 is designed in such a manner that, in response to torque-converter lockup clutch 20 being closed during the closing interval, setpoint value sw is, on one hand, selected as a function of time, taking into consideration the time characteristic in the form of a characteristic curve according to FIG. 2, and on the other hand, taking into consideration the input torque E currently applied to input shaft 2 of converter 1. In addition, input torque E applied to converter 1 is monitored by sensor 32 inside the closing interval. In response to a change in input torque E of more than a specifiable tolerance deviation, slip s of converter 1 is determined and used as a new initial value, as a basis for the time characteristic of setpoint value sw, which would occur in response to input torque E now being applied, when torque-converter lockup clutch 20 is completely opened.

For this purpose, control unit 26 is designed in such a manner, that it is checked, as a function of currently ascertained input torque E, if the currently determined time characteristic for setpoint value sw is still appropriate. If this is no longer the case as a result of a change in input torque E, then the previously followed characteristic curve for setpoint value sw as a function of time is replaced by the characteristic curve, which would correspond to the input torque E being applied now. In the case in which, for example, the middle characteristic curve according to FIG. 2 was initially followed for setpoint value sw, this could mean that control unit 26 switches over in response to a significant increase in input torque E, and, for the further course, e.g. the upper one of characteristic curves sw represented in FIG. 2 selects the value for slip s, which results from the selected time characteristic for the current time within the closing interval, the selected time characteristic converting the initial value calculated from currently applied input torque E, into the target value.

In other words, control unit 26 is designed in such a manner that, in response to a change in input torque E, a characteristic curve is used as a basis for setpoint value sw, for the further course of the closing operation of torque-converter lockup clutch 20, the characteristic curve converting an initial value for slip s corresponding to the currently applied input torque E, into the target value. To this end, control unit 26 is designed to ensure a reliable determination of a suitable initial value for slip s corresponding to currently applied input torque E. In the exemplary embodiment, a data storage unit 36 has, for this purpose, a data record stored in it in the form of a characteristics map, from which a slip value s can be derived for each input torque E. The slip value is to be used as an initial value, as a basis for determining the setpoint value sw for slip s as a function of time. In this context, the characteristics map stored in data storage unit 36 could have been generated, for example, using calibration measurements.

However, control unit 26 can alternatively be designed for calculating a suitable initial value for setpoint value sw of slip s as a function of currently applied input torque E. In this context, the initial value can be calculated from applied input torque E, by taking performance figure A into consideration. In so doing, the relationship of the input torque of converter 1 to speed ne of input shaft 2 is utilized according to the following equation:

ne=K*Λ*10³*(nₚᵤₘₚ/1000)²

where K is a suitable conversion factor and Λ is the performance figure of converter 1. Therefore, performance figure Λ of converter 1 can be calculated, when input torque E and speed ne of input shaft 2 are known. On the other hand, performance figure Λ is clearly related to the ratio of speed ne of input shaft 2 to speed na of output shaft 4, as is exemplarily represented in FIG. 3 in the form of a characteristic curve.

On this basis, control unit 26 can calculate performance figure Λ of converter 1 in a first step, from measured input torque E and measured speed ne of input shaft 2. By evaluating the appropriate characteristic stored in data storage unit 36, the ratio of speed ne of input shaft 2 to speed na of output shaft 4 can be calculated from performance figure Λ in a second step. In a third step, the corresponding initial value for slip s can then be determined from this speed ratio.

In addition, control device 24 is also designed for the especially reliable detection of a suitable starting time for controlling the slip of torque-converter lockup clutch 20 during the closing interval. Such a particularly suitable starting time is namely given by the fact that actuating piston 22 of torque-converter lockup clutch 20 comes to rest against housing part 6 at this very time. In other words, the end play of torque-converter lockup clutch 20 has just been overcome at this instance, so that, from this point on, torque-converter lockup clutch 20 can transmit a torque to output shaft 4.

In order to detect this time point that is regarded as particularly suitable, control unit 26 is designed to monitor the time characteristic of slip s of torque-converter lockup clutch 20, for a decline. For when torque-converter lockup clutch 20 starts to transmit a torque, slip s of torque-converter lockup clutch 20 or converter 1 should decrease. Therefore, such a decline is a particularly suitable means for detecting the mentioned starting time.

After detecting such a decline, control unit 26 actively controls the slip of torque-converter lockup clutch 20. From this time on, control unit 26 selects a value for the clamping pressure of converter 1 as a function of a coupling torque to be transmitted, and as a function of setpoint value sw for slip s of torque-converter lockup clutch 20. A resulting time characteristic of clamping pressure p for converter 1, preselected by control unit 26, and a resulting time characteristic of slip s of converter 1 or torque-converter lockup clutch 20, determined in the same time range, are represented in FIG. 4 as time-dependency diagrams.

To initiate the closing operation of torque-converter lockup clutch 20, control unit 26 initially selects a comparatively high clamping pressure at time T0. This causes actuating piston 22 of torque-converter lockup clutch 20 to move in the direction of housing part 6, but without initially making mechanical contact. Actuating piston 22 only comes into mechanical contact with housing part 6 at a time T1, after traversing a corresponding dead space. Therefore, slip s of torque-converter lockup clutch 20 or converter 1 diminishes from time T1 on. As soon as this decrease in slip s is detected by control unit 26 at time T1, using the measuring signals supplied to it by sensors 28, 30, the start of power transmission or friction contact of torque-converter lockup clutch 20 is deduced. Consequently, the slip control of torque-converter lockup clutch 20 commences now, so that the clamping pressure is now reduced from its comparatively high initial value, and set as a function of the coupling torque to be transmitted, and as a function of currently selected setpoint value sw for slip s of torque-converter lockup clutch 20.

What is claimed is:

1. A method for operating a torque-converter lockup clutch (20) for a hydrodynamic torque converter (1), where the slip of the torque converter (1) is adjusted using a setpoint value (sw), while the torque-converter lockup clutch (20) is being closed, the setpoint value (sw) being continuously selected inside a closing interval, as a function of time, and taking into account the input torque (E) currently applied to the torque converter (1).

2. The method as recited in claim 1, where, for the time-dependence of the setpoint value (sw), a preselected time characteristic is taken into account, which converts the slip existing at the beginning of the closing interval as an initial value, into a target value, within the closing interval.

3. The method as recited in claim 2, where a linear transition from the initial value to the target value is provided as a time characteristic inside the closing interval.

4. The method as recited in claim 2 or 3, where the input torque (E) applied to the torque converter (1) is monitored inside the closing interval; in response to the input torque (E) changing by more than a specifiable tolerance deviation, the slip of the torque converter (1) being ascertained and taken as a basis for a new initial value, which would appear at this input torque (E) in the case of a completely opened torque-converter lockup clutch (20).

5. The method as recited in claim 4, where the value resulting from the preselected time characteristic for the current time inside the closing interval is selected as the setpoint value (sw) for the slip, the time characteristic converting the initial value ascertained using the currently applied input torque (E) into the target value.

6. The method as recited in claim 4 or 5, where the slip to be used as a new initial value, as a basis for the applied input torque (E) is determined using a stored characteristics map.

7. The method as recited in claim 4 or 5, where the slip to be used as a new initial value, as a basis for the applied input torque (E) is calculated from the applied input torque (E), taking the performance figure of the torque converter (1) into consideration.

8. The method as recited in one of claims 1 through 7, where, in order to adjust the slip, a controlled parameter is provided for setting a clamping pressure for the torque converter (1).

9. The method as recited in one of claims 1 through 8, where the time characteristic of the slip is monitored for a decline, in order to detect the start of power transmission in the torque-converter lockup clutch (20).

10. The method as recited in claim 9, where, after a decrease in the slip is detected, a clamping pressure for the torque converter (1) is set as a function of a coupling torque to be transmitted, and as a function of the setpoint value (sw) for the slip of the torque-converter lockup clutch (20).

11. A control device (24) for a torque-converter lockup clutch (20) for a hydrodynamic torque converter (1), where a sensor (32) for detecting the input torque (E) applied to the torque converter (1) is connected to a control unit (26), which selects a setpoint value (sw) for the slip of the torque converter (1) as a function of time, and taking into consideration the input torque (E) currently being applied to the torque converter (1).

12. The control device (24) as recited in claim 11, whose control unit (26) is connected on the output side to means for setting a clamping pressure for the torque converter (1).

13. The control device (24) as recited in claim 11 or 12, whose control unit (26) is connected to a data storage unit (36), in which a time characteristic for the setpoint value (sw) of the slip is stored, a slip existing at the beginning of a closing interval as an initial value being converted into a target value within the closing interval, in accordance with the time characteristic for the setpoint value of the slip.

14. The control device (24) as recited in claim 13, in whose data storage unit (36) a data record is stored, from which a slip value can be derived for each input torque (E), the slip value being intended to be used as an initial value, as a basis for determining the setpoint value (sw) for the slip as a function of time.

15. The control device (24) as recited in claim 13, in whose data storage unit (36) a characteristics map is stored, which, inside specifiable interval boundaries, assigns each performance figure of the torque converter (1) a corresponding slip value.
